(19) United States
(12) Patent Application Publication
(10) Pub. No.: US 2002/0137382 A1
(43) Pub. Date: Sep. 26, 2002

(54) Power adapter device

(76) Inventors: Hironori Shirakura, Kaho-gun (JP); Hidetoshi Hamai, Iizuka-shi (JP)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 09/980,378

(22) PCT Filed: Mar. 28, 2001
(86) PCT No.: PCT/JP01/02563

(30) Foreign Application Priority Data
Mar. 28, 2000 (JP) 88052/2000

(51) Int. Cl. H01R 27/00

(52) U.S. Cl. 439/218

(57) ABSTRACT

An inlet (13) formed on an adapter main body (11) comprises AC contacts (31a), (31b) for connecting an AC cable part (55) and DC contacts (33a), (33b) for connecting a DC cable part (65). The AC contacts (31a), (31b) and the DC contacts (33a), (33b) are formed in the inlet (13) at positions different from each other. Upon AC/DC switching, either one of the AC cable part (55) and the DC cable part (65) is inserted into the inlet (13) so that connection is switched into an AC side or a DC side.

### TECHNICAL FIELD

This invention relates to a power adapter device for producing, through connection of an AC cable part to the adapter itself or connection of a DC cable part to the adapter itself, a DC output to an object apparatus to be supplied with a DC power.

### BACKGROUND ART

As illustrated in FIG. 1, an existing power adapter device comprises an adapter main body 1 formed into a box-like shape. The adapter main body 1 has one surface 1a provided with an AC inlet 1b for an AC input and a DC inlet 1c for a DC input. Inside the adapter main body 1, an AC/DC converter 2 and a DC/DC converter 3 are arranged.

The AC inlet 1b has an AC connector 4 arranged inside the adapter main body 1. The AC connector 4 has AC contacts 4a. The AC/DC converter 2 is connected to the AC contacts 4a.

The DC inlet 1c for a DC input formed on the one surface 1a of the adapter main body 1 has a DC connector 5 arranged inside the adapter main body 1. The DC connector 5 has a DC contact 5a. The DC contact 5a is connected to the DC/DC converter 3.

In the adapter main body 1, the AC/DC converter 2 and the DC/DC converter 3 are connected in parallel with each other to a selection switch 6 at their input-side junction. The selection switch 6 serves to switch connection to the AC/DC converter 2 when the AC inlet 1b side is used and to switch connection to the DC/DC converter 3 when the DC inlet 1c side is used. For switching of the connection between the AC/DC converter 2 and the DC/DC converter 3, a circuit for carrying out automatic switching in response to an input signal may be provided inside the adapter main body 1.

The AC/DC converter 2 and the DC/DC converter 3 are connected to a power cable 7a led out from the adapter main body 1. The power cable 7a has a terminal end connected to an adapter-side DC plug 7b.

To the AC inlet 1b, an AC cable part 8 is connected. The AC cable part 8 comprises an AC cable 8a, an AC connector 8b connected to one end of the AC cable 8a, and an AC plug 8c connected to the other end of the AC cable 8a.

To the DC inlet 1c, a DC cable part 9 is connected. The DC cable part 9 comprises a DC cable 9a, a DC connector 9b connected to one end of the DC cable 9a, and a DC plug 9c connected to the other end of the DC cable 9a.

However, the existing power adapter device must have both the AC inlet 1b for an AC input and the DC inlet 1c for a DC input. Therefore, the adapter main body 1 inevitably has a large size and a connecting operation is troublesome.

Furthermore, the existing power adapter device is disadvantageous in that a defect such as circuit breakdown might be caused to occur if the AC cable part 8 and the DC cable part 9 are simultaneously connected to the AC inlet 1b and the DC inlet 1c through the AC connector 8b and the DC connector 9b, respectively.

Therefore, it is an object of this invention to provide a power adapter device which can be used for either of DC and AC by arranging AC contacts and DC contacts at different positions in a single inlet and connecting either one of an AC cable part and a DC cable part to the single inlet.

It is also an object of this invention to provide a power adapter device which has a small and simple structure, which can be reduced in number of components, and which can be miniaturized.

It is also an object to provide a power adapter device capable of avoiding a factor causing circuit breakdown even if a selection switch for AC contacts and DC contacts is not used.

### DISCLOSURE OF THE INVENTION

According to this invention, there is provided a power adapter device for producing, through connection of an AC cable part (55) to the adapter itself (11) or connection of a DC cable part (65) to the adapter itself, a DC output to an object apparatus to be supplied with a DC power, wherein the power adapter device comprises a single inlet (13) for removably receiving either one of the AC cable part (55) and the DC cable part (65), the inlet (13) comprising conductive AC contacts (31a), (31b) for connecting the AC cable part (55) and DC contacts (33a), (33b) for connecting the DC cable part (65), the AC contacts (31a), (31b) and the DC contacts (33a), (33b) being formed in the inlet (13) at positions different from each other.

### BRIEF DESCRIPTION OF THE DRAWING

FIG. 1 is a perspective view showing an existing power adapter device.

FIG. 2 is a perspective view showing a power adapter device according to one embodiment of this invention.

FIG. 3 is a front view showing an inlet of the power adapter device illustrated in FIG. 2.

FIG. 4 is a front view showing an AC cable connector of the power adapter device illustrated in FIG. 2.

FIG. 5 is a front view showing a DC cable connector of the power adapter device illustrated in FIG. 2.

FIG. 6 is a block diagram showing a schematic circuit structure of the power adapter device illustrated in FIG. 2.

FIG. 7 is a sectional view showing the power adapter device illustrated in FIG. 2 in a state where the DC cable connector is fitted into a fitting portion.

### BEST MODE FOR EMBODYING THE INVENTION

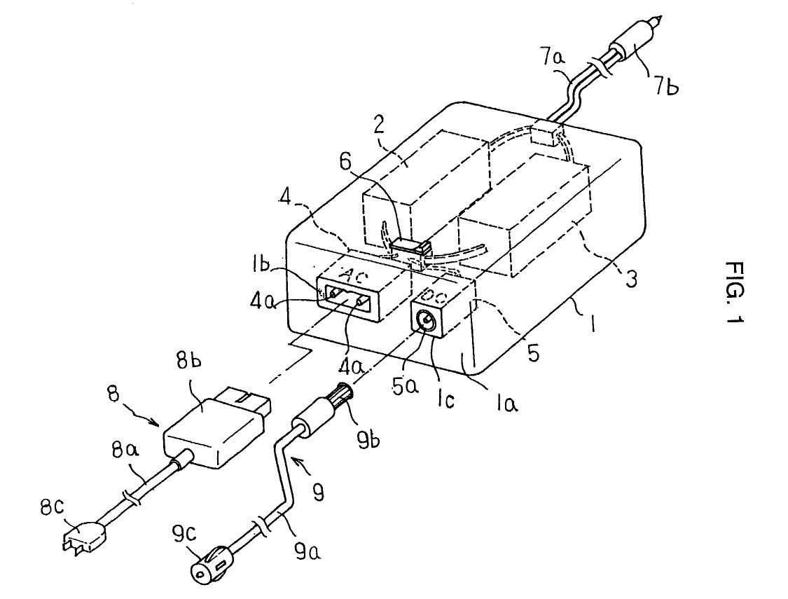

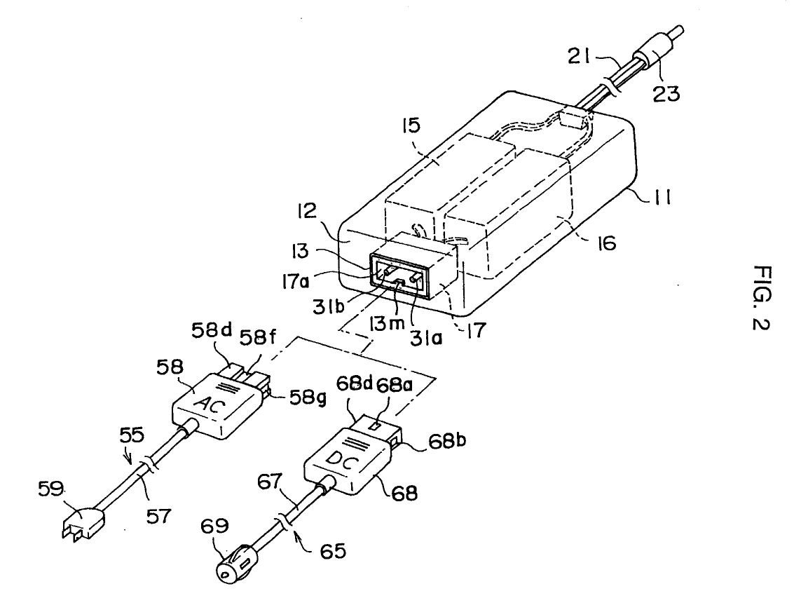

FIG. 2 shows a power adapter device according to one embodiment of this invention. Referring to FIG. 1, the power adapter device according to this embodiment comprises an adapter main body 11 formed into a box-like shape, an AC cable part 55, and a DC cable part 65.

The adapter housing body 11 has one surface 12 provided with a single inlet 13 for removably receiving either one of the AC cable part 55 and the DC cable part 65.

Inside the adapter main body 11, an AC/DC converter 15 and a DC/DC converter 16 are arranged. The converters 15 and 16 are connected to a power cable 21 led out from the adapter main body 11. The power cable 21 has a terminal end connected to an adapter-side DC plug 23.

The inlet 13 comprises a single AC-DC connector 17 having a fitting portion 17a for receiving an AC cable connector 58 or a DC cable connector 68.

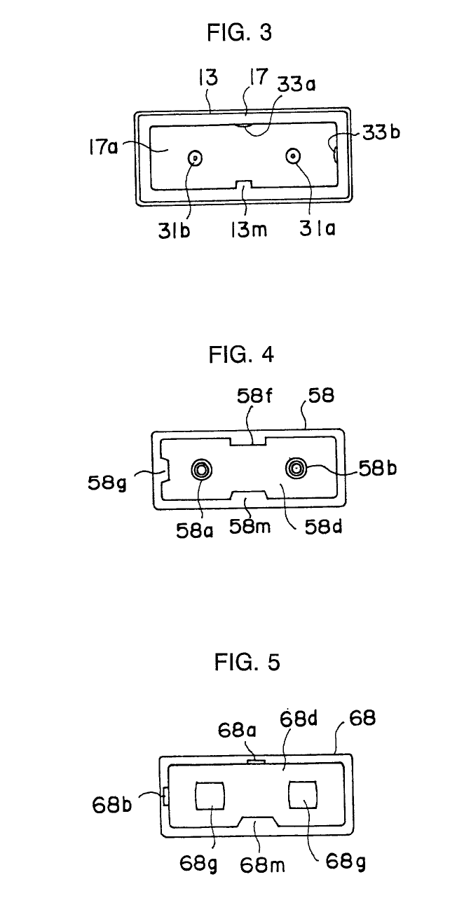

As illustrated in FIG. 3 also, the fitting portion 17a is provided with AC contacts 31a, 31b and DC contacts 33a, 33b. The AC contacts 31a, 31b and the DC contacts 33a, 33b are formed in the inlet 13 at positions different from each other.

As illustrated in FIG. 4, the AC cable connector 58 comprises cable-connection conductive AC contacts 58a, 58b to be brought into contact with the AC contacts 31a, 31b. As illustrated in FIG. 5, the DC cable connector 68 comprises cable-connection DC contacts 68a, 68b to be brought into contact with the DC contacts 33a, 33b.

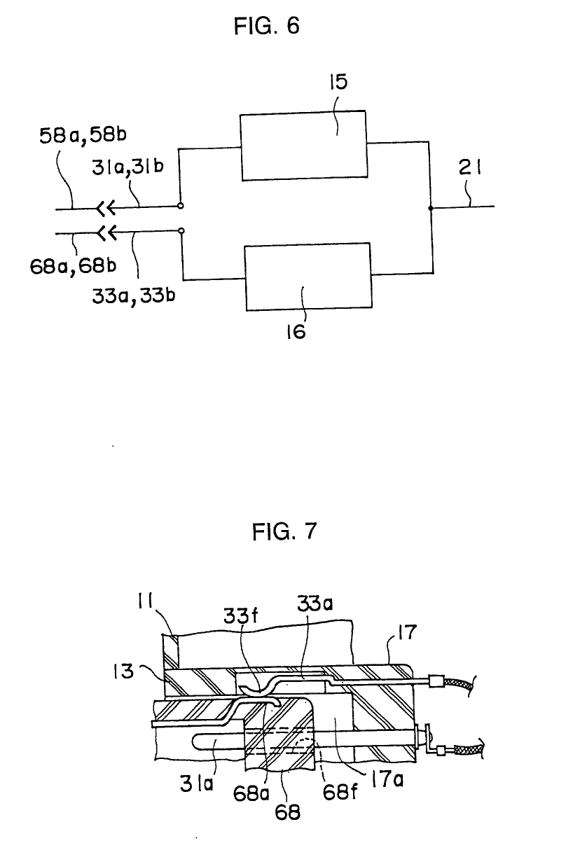

As illustrated in FIG. 6 also, the AC contacts 31a, 31b are connected to the AC/DC converter 15 in the adapter main body 11. The DC contacts 33a, 33b are connected to the DC/DC converter 16 in the adapter main body 11.

In addition to the AC cable connector 58, the AC cable part 55 comprises an AC cable 57 connected to the AC cable connector 58 and an AC plug 59 connected to one end of the AC cable 57. In addition to the DC cable connector 68, the DC cable part 65 comprises a DC cable 67 connected to the DC cable connector 58 and a DC plug 69 connected to one end of the DC cable 67.

The AC cable connector 58 has an AC fitting portion 58d to be fitted to the fitting portion 17a and provided with the cable-connection AC contacts 58a, 58b to be brought into contact with the AC contacts 31a, 31b. The DC cable connector 68 has a DC fitting portion 68d to be fitted to the fitting portion 17a and provided with the cable-connection DC contacts 68a, 68b to be brought into contact with the DC contacts 33a, 33b.

Each of the AC fitting portion 58d and the DC fitting portion 68d is formed into a shape dimensioned so that it is fitted to the fitting portion 17a. In this embodiment, the fitting portion 17a comprises an insulator. The fitting portion 17a has a large groove having an opening on one surface. Each of the AC fitting portion 58d and the DC fitting portion 68d is removably fitted to the fitting portion 17a.

FIG. 7 shows a state where the DC cable connector 68 illustrated in FIG. 1 is fitted to the fitting portion 13. Referring to FIG. 6, the AC contacts 31a, 31b are a pair of pin contacts. These pin contacts extend from the bottom of the fitting portion 17a into the groove of the fitting portion 17a.

The cable-connection AC contacts 58a, 58b are socket-shaped contacts for receiving the AC contacts 31a, 31b to be brought into contact therewith upon fitting.

Each of the DC contacts 33a, 33b has an intermediate portion held by the fitting portion 17a and an end provided with a contact point 33f protruding from an inner wall surface. Each of the cable-connection DC contacts 68a, 68b has an end portion located on an outer surface of the DC fitting portion 68d. Therefore, upon fitting, the contact point 33f is brought into contact with the end portion of the DC fitting portion 68d.

Without being restricted to this embodiment, it is sufficient to provide the AC contacts 31a, 31b and the DC contacts 33a, 33b in a state where either of these contacts protrude on a side surface of the fitting portion 17a parallel to a fitting direction in which the AC fitting portion 58d or the DC fitting portion 68d is faced upon fitting.

The AC fitting portion 58d has DC contact accepting portions 58f, 58g defining gaps to receive the DC contacts 33a, 33b when it is fitted to the fitting portion 13. The DC fitting portion 68d has AC contact accepting portions 68f, 68g defining gaps to receive the AC contacts 31a, 31b when it is fitted to the fitting portion 17a.

Furthermore, on an opening side of the fitting portion 17a, a protrusion 13m is formed to be butted to a fitting surface of the AC fitting portion 58d or the DC fitting portion 68d to inhibit further insertion in case where the AC cable connector 58 or the DC cable connector 68 is inserted in a position reversed from that illustrated in the figure.

On the other hand, the AC fitting portion 58d is provided with an escaping groove 58m so that the AC fitting portion 58d is received in the fitting portion 13 upon normal insertion. Similarly, the DC fitting portion 68d is provided with an escaping groove 68m.

As illustrated in FIG. 1, only one of the AC cable connector 58 and the DC cable connector 68 can be connected to the single inlet 13 of the adapter main body 11. Thus, the AC cable connector 58 and the DC cable connector 68 are not simultaneously connected to the inlet 13.

When the AC fitting portion 58d is fitted to the fitting portion 17a, the AC contacts 31a, 31b are brought into contact with the cable-connection AC contacts 58a, 58b. In this case, there is no chance at all that the AC contacts 31a, 31b and the DC contacts 33a, 33b are connected to each other, because they are formed in the fitting portion 17a at the positions different from each other and the DC contacts 33a, 33b are located in the DC contact accepting portions 58f, 58g of the AC fitting portion 58d.

On the other hand, when the DC fitting portion 68d is fitted to the fitting portion 17a, the DC contacts 33a, 33b are brought into contact with the cable-connection DC contacts 68a, 68b. In this case, there is also no chance that the AC contacts 31a, 31b and the DC contacts 33a, 33b are connected to each other, because they are formed in the fitting portion 17a at the positions different from each other and the AC contacts 31a, 31b are located in the AC contact accepting portions 68f, 68g of the DC fitting portion 68d.

As described above in conjunction with the embodiment, in the power adapter device according to this invention, the AC contacts 31a, 31b and the DC contacts 33a, 33b are formed in the single inlet 13 at the positions different from each other. Thus, upon AC/DC switching, either one of the AC cable part 55 and the DC cable part 65 is simply inserted into the single inlet 13 so that connection is switched into the AC side or the DC side.

### INDUSTRIAL APPLICABILITY

As described above, the power adapter device according to this invention is useful as a device for producing, through connection of a DC cable part to an AC cable part to the adapter, a DC output to an object apparatus to be supplied with a DC power and as a device for producing, through connection of a DC cable part to the adapter, a DC output to the object apparatus to be supplied with a DC power.

The adapter-side DC plug is connected to a typical electronic apparatus such as a notebook-type personal computer. The AC plug is connected, for example, to a domestic-purpose outlet. The DC plug is inserted and connected, for example, to a cigar lighter socket of an automobile.

1. A power adapter device for producing, through connection of an AC cable part to said adapter itself or connection of a DC cable part to said adapter itself, a DC output to an object apparatus to be supplied with a DC power, wherein said power adapter device comprises:
a single inlet for removably receiving either one of said AC cable part and said DC cable part;
said inlet comprising conductive AC contacts for connecting said AC cable part and DC contacts for connecting said DC cable part;
said AC contacts and said DC contacts being formed in said inlet at positions different from each other.

2. A power adapter device as claimed in claim 1, wherein said AC cable part comprises an AC cable connector while said DC cable part comprises a DC cable connector, said inlet comprising an AC-DC connector having a single fitting portion for receiving said AC cable connector or said DC cable connector, said fitting portion being provided with said AC contacts to be brought into contact with conductive cable-connection AC contacts of said AC cable connector and said DC contacts to be brought into contact with cable-connection DC contacts of said DC cable connector.

3. A power adapter device as claimed in claim 2, wherein said AC cable connector has an AC fitting portion to be fitted to said fitting portion and provided with said cable-connection AC contacts to be brought into contact with said AC contacts, said DC cable connector having a DC fitting portion to be fitted to said fitting portion and provided with said cable-connection DC contacts to be brought into contact with said DC contacts, said AC fitting portion having DC contact accepting portions defining gaps to receive said DC contacts when it is fitted to said fitting portion, said DC fitting portion having AC contact accepting portions defining gaps to receive said AC contacts when it is fitted to said fitting portion.

4. A power adapter device as claimed in claim 3, wherein said AC contacts and said DC contacts are provided in a state where either of these contacts protrude on a side surface of said fitting portion parallel to a fitting direction in which said AC fitting portion or said DC fitting portion is faced upon fitting.
